(19) United States
(12) Patent Application Publication
(10) Pub. No.: US 2008/0300926 A1
(43) Pub. Date: Dec. 4, 2008

(54) Method and system for allowing user check-in

(75) Inventors: Pierre-Philippe Di Costanzo, Vallauris - Le Golf-Juan (FR); Karine Miens Gautherie, Valbonne (FR); Marielle Hemon, Saint Laurent du Var (FR)

Correspondence Address: Gregory J. Lavorgna;Drinker Biddle & Reath LLP, 1 Logan Square, 18th and Cherry Street, Philadelphia, PA, 19103, US

(73) Assignee: Amadeus S.A.S., Sophia Antipolis Cedex (FR)

(21) Appl. No.: 11/809,056

(22) Filed: May 30, 2007

(51) Int. Cl. G06Q 10/00

(52) U.S. Cl. 705/5

(57) ABSTRACT

A method for changing the state of a pre-booked ticket from a first booked-state to a second check-in state, wherein the method includes a mobile device communicating through an IM communication system with a check-in desk service. The mobile device also comprises an identification instrument for a user, said check-in desk service having access to the pre-booked ticket. The method comprises the steps of connecting the mobile device to an appropriate network in order to communicate with the check-in desk, sending the identification instrument through the IM communication system to the check-in desk in order to access to the pre-booked ticket, requesting to change the pre-booked ticket state from booked to check-in and receiving an electronic boarding pass on the mobile device to access to a boarding gate.

### FIELD OF THE INVENTION

The present invention relates to a method and system for allowing check-in, in particular in the travel industry, in order to allow customers to check-in with a mobile device.

### BACKGROUND OF THE INVENTION

There are several patent documents relating to methods and systems, for allowing customers to create or to modify the data file relating to personal travel details. These systems allow customers to buy, for instance, a flight ticket. Once the flight ticket is bought, customers can be allowed to modify data relating to the flight.

US 2006/0156063 discloses a system and a method to allow a customer to communicate with a transaction processor, using instant messaging (IM). In one embodiment of the system and a method according to this document, the IM-transaction integration functionality is hosted as middleware on a system, between a user device and the transaction processor. This means that the user can correspond with an intermediate system using an IM protocol. This intermediate system is then able to translate the data obtained by the IM communication in order to contact a network enabled transaction system. This network enabled transaction system is for instance a website of a travel company on the Internet.

In one illustrated embodiment, the middleware is a chat box. The customer can start an IM chat with this chat box. The chat box is able to solicit IM responses comprising transaction information which is needed to satisfy a set of requests by the transaction processor. The result of the IM communication between the chat box and the user are then used as a set of user instructions on the transaction processor, which may be an electronic reservation system. The system and method, according to US 2006/0156063 provide an intermediate system which allows a user to access existing reservation systems, like websites, using the advantages of instant messaging. However, the system and method do not provide any possibility to allow the users to access existing pre-booked tickets to check-in themselves.

### SUMMARY OF THE INVENTION

An object of the present invention is to alleviate at least some of the problems associated with the prior art system and method for allowing a user to check-in with a mobile device.

More particularly, the present invention discloses a method for changing the state of a pre-booked ticket from a first booked-state to a second check-in state, wherein the method includes a user mobile device communicating through an IM communication system with a check-in desk service, said mobile device also comprising an identification means of a user, said check-in desk service having access to the pre-booked ticket wherein the method comprises the steps of connecting the mobile device to an appropriate network in order to communicate with the check-in desk sending the identification means through the IM communication system to the check-in desk in order to access to the pre-booked ticket, requesting to change the ticket state from booked to check-in and receiving an electronic boarding pass on the mobile device to access to a boarding gate.

More particularly, the invention discloses a system comprising means adapted for carrying out the steps of the said method.

This invention has a number of advantages. When creating a data file on a transaction processor, for instance when a reservation on a reservation processor is created, a user profile including an IM-ID is added. That means that, at the time that the data file is created, a unique identity is added to the data file. This unique identity allows for IM communication.

At a later date, when a user accesses the data file, the user profile including the IM-ID is used to check whether or not access should be allowed to the data file. In practice, this means that a user, having for instance a mobile device allowing IM communication, can use IM to access the data file and to make amendments to the data file. This allows, for instance, a check-in at an airport or on the way to the airport using a mobile device, e.g. for example using online checking from a mobile.

### BRIEF DESCRIPTION OF THE DRAWINGS

Reference will now be made, by way of example, to the accompanying drawings, in which:

FIG. 1 shows, at a high level, the different elements of the system according to the present invention.

FIG. 2 is a flow chart showing the method, according to the present invention.

### DETAILED DESCRIPTION OF THE EMBODIMENTS

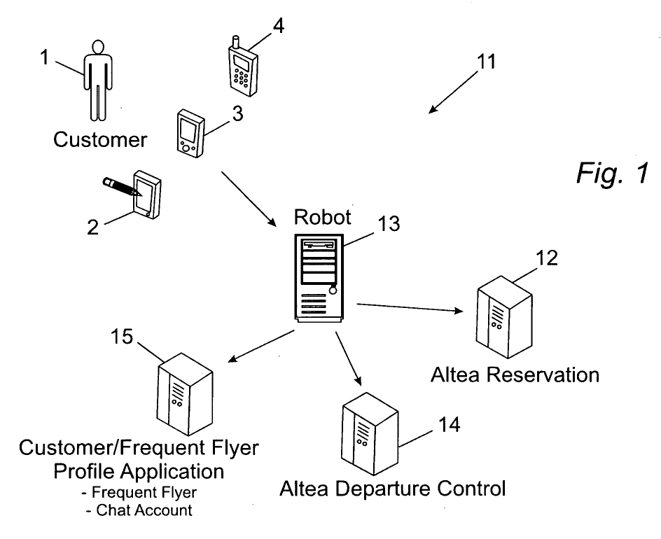

In FIG. 1, an example is shown of the use of the method and system according to the present invention in the travel industry. A customer 1 has the ability to interact with a computerized system 11 via instant messaging (IM). In a first instance, a customer 1, by any appropriate means can create a reservation, for instance, for a flight ticket. This reservation will be stored in a reservation processor of a check-in desk service 12 in the form of a pre-booked ticket. The reservation processor is for instance the customer reservation processor of AMADEUS (ALTEA). At the time the reservation is stored in the reservation processor 12, an instant message ID (IM-ID) of the customer is added to the details of the pre-booked ticket or reservation on the processor 12. This means that the reservation details or the pre-booked ticket information on the processor 12 are linked with a unique identification of the customer. Once the data file on the reservation processor 12 is created, a customer 1 can be allowed to access and control the data files on the reservation processor 12 located at a check-in desk service. At this moment, the pre-booked ticket is in a first booked-state.

According to the present invention, the system is provided with a robot 13. This robot (or chat robot as it is commonly known) 13, on the one hand, is able to communicate with the reservation processor 12. On the other hand, the robot 13 is able to communicate with the customer 1. In order to communicate with the robot 13, the customer can use any preferred device. The customer, for instance, can use a PDA 2, a blackberry 3 or a cell phone 4. Any other suitable mode of mobile devices can also be used. Alternatively, the customer can use an other communication device, such a personal computer. The robot 13 is set up in order to be able to communicate with one of the devices 2 to 4 using IM. In order to realize this, the robot 13 is registered on all main IM networks through an existing network such as GPRS network, for instance. If the customer wants to access a data file on the reservation processor 12, the customer 1 interacts with the robot 13 using a preferred device 2 to 4 using a natural language. The robot 13 provides natural language recognition in the interaction with the customer 1 in order to provide an intuitive interface not requiring specific user knowledge of the application devices. In order to be able to process natural language instructions, the chat robot will be connected to an application that provides verb for automatic business services, for example “check-in”.

According to the invention, the customer 1 will start a normal chat session with the robot 13. The robot 13 uses a verb provided by the system proprietor to retrieve the profile associated to the IM-ID of the customer 1 or the customer can send his IM-ID to the chat robot 13. Once the data is retrieved from the reservation processor 12, the robot 13 can identify what are the available actions. Depending on the information stored on the reservation processor, several operations may be available or not available as the case may be. For instance, if there is a booking available in the form of a pre-booked ticket on the reservation processor, the robot 13 can propose to the customer 1 to perform the check-in of a flight. Thus, the booked state of the pre-booked ticket will change into a check-in state.

Each action performed by the customer 1 is translated by the robot 13 in unitary actions (verbs) processed by applications which are available in the reservation processor 12 of the check-in desk service. After the check-in, the customer 1 receives an electronic boarding card on his mobile device. This card can be a bar code, for instance. Thus, the customer 1 can access the boarding gate.

As show in FIG. 1, the chat robot 13 is connected to a reservation processor 12 but also to a departure control processor 14. The system can further be completed by adding a processor 15 with information on frequent users, such as details on frequent flyers.

With this system, according to FIG. 1, a customer 1 can correspond with the robot 13 using natural language. The robot 13 will, in a first instance, be able to check whether the customer 1 is able to obtain any information from the system. Once the robot 13 has identified that the customer 1 is entitled to access to information, the robot can either give access to or allow modifications to a reservation on the reservation processor 12. Moreover, the robot 13 can use the information on the different processors 12, 14 and 15, in order to allow check-in, for example. Because of the link with the frequent flyers processor 15, additional information can also be processed.

The following list of non-exhaustive functionalities is proposed:
basic check-in and passenger acceptance,
seat assignment,
specification of meal preference,
regulatory information,
password issuance adapted to the type of the device (MMS, RFID, etc),
read and manage frequent flyer card, and
manage flight disruption problems.

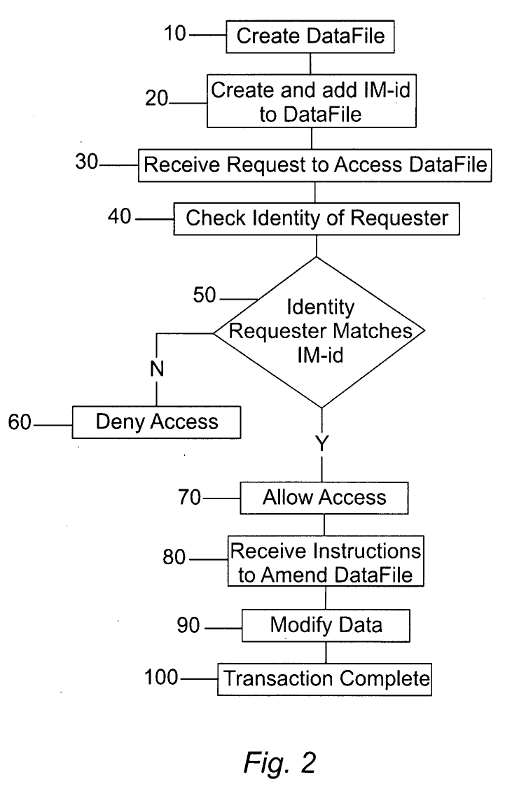

FIG. 2 shows a flow chart wherein in a first step 10 a data file is created. This data file includes an instant messaging identifier (IM-ID). As will described below, the presence of this IM-ID will allow instant messaging (IM) to obtain access to the data file and to make alterations to the data file. Moreover, the presence of this IM-ID provides security in order to obtain an absolute guarantee that the requestor is allowed to access and modify the data file. This allows reliance on the authentication provided by the IM service. In a third step 30, a request is received in order to access the data file created in step 10. Before access is either allowed or accessed in step 40, the identity of the requester is checked. In the next step 50, it is either concluded that the identity of the requestor matches or doesn't match the IM-ID which has been added to the data file in step 20. If there is no match, access to the data file is denied in step 60. Alternatively, if in step 50 it is concluded that the identity of the requestor matches the IM-ID of the data file, then access is allowed to the data file in step 70. Access to the data file means that the requestor is able to review existing data in the data file. If the data file relates to travel information, the requestor can check information like the departure time and the arrival time, etc. . . .

It is also possible that in step 80, instructions are received in order to amend the data file, this is due to the fact that in step 50 it is concluded that the requestor is the only person who can have access to amend the data file, if required. After receiving instructions to amend the data file in step 80, the data will be modified in step 90.

When the data file relates to travel information, any modification may mean that the requester changes the date or hour of departure. It is also possible that other information may change, for instance the seating position or meal request, as described above.

Since the system according to the present invention provides security in order to obtain an absolute guarantee that the requestor is allowed to access and modify the data file, the system can allow changes to the data file which are highly sensitive for security reasons. The system can, for instance, allow a customer to check-in and the system is able to provide a customer with a boarding pass.

After the modification of the data the transaction is complete 100. A practical use of the method according to FIG. 1, will now be described with reference to FIG. 1.

### EXAMPLES

In order to further explain the functionality of the system, the following communication could take place between a customer 1 and a chat robot 13. A customer 1 has booked a flight, via any current channel, such as a website on the Internet. This flight is for instance BA 341 from Nice to London for the 26 of August. On the 25 of August, the customer 1 wants to perform a check-in of a flight. The customer connects to the IM client, via a computer or via a preferred mobile device 2-4 and starts the chat session with the chat robot of British Airways (DCS-BA).

User: “I'm flying to London”

(The chat robot has now identified the word “flying”. The chat robot interacts with the check-in application to identify the customer. In order to identify the customer, the chat robot will use the IM-ID and the associated products to this IM-ID available on the processors 12, 14 or 15. Any other mean of identification available for the check-in application may be used at this point, using a flight number, a departure city and the like.)

DCS-BA: “Hello, M. Porter, I'm looking at your booked trip. You are now checked in on flight BA 341 from Nice to London on the 26 of August”

DCS-BA: “Do you have hand luggage?”

User: “Yes”

(The chat robot has identified a new keyword. The chat robot will update the check-in information).

DCS-BA: “Do you have any luggage to be loaded in the hold of the aircraft?”

User: “No”

(The robot has identified a new keyword. The robot will further update the check-in information.)

DCS-BA: “Do you have any seat preference?”

User: “I'd like to be near a window, at the front of the plane.”

(The chat robot has now identified the keywords “window” and “front”.)

DCS-BA: “M. Porter, your current seat is 6A. As a “Gold member” you are allowed to change your seat assignment. Would you like to change your seat assignment?”

User: “No”

DCS-BA: “You are checked-in for flight BA 341 from Nice to London on the 26 of August. You have only a hand-luggage and your seat is 6A. Since you are connecting through a mobile device, your boarding pass has been sent via MMS to your registered mobile number +31 6 XXXXXXXX.”

(The chat robot has now finished the transaction.)

As shown in the example, the chat robot has provided access to the customer to his reservation on the reservation processor 12. The chat robot has also modified information on the corresponding processors 14 and 15 in order to perform the check-in and to update the check-in information and the frequent flyer information.

It will be appreciated that this invention may be varied in many different way and still remain within the intended scope and spirit of the invention.

1. Method for changing the state of a pre-booked ticket from a first booked-state to a second check-in state, wherein the method includes a mobile device communicating through an IM communication system with a check-in desk service, said mobile device also comprising an identification means of a user, said check-in desk service having access to the pre-booked ticket:
wherein the method comprises the steps of:
connecting the mobile device to an appropriate network in order to communicate with the check-in desk;
sending the identification means through the IM communication system to the check-in desk in order to access to the pre-booked ticket;
requesting to change a pre-booked ticket state from booked to check-in;
receiving an electronic boarding pass on the mobile device to access to a boarding gate.

2. The method of claim 1, further comprising sending instructions to the check-in desk service to change the pre-booked ticket state.

3. The method of claim 1, further comprising sending instructions to a chat robot, manipulating those instructions by the chat robot in order to create a request to access the pre-booked ticket and forwarding the request to the check-in service.

4. The method of any of claim 1, further comprising using an IM protocol suitable for mobile devices.

5. A system comprising means adapted for carrying out the steps of the method, according to one of the claim 1.

6. A device comprising means adapted for carrying out the steps of the method according to anyone of the claim 1.

7. A computer program comprising instructions for carrying out the steps of the method according to anyone of the claim 1, when said computer program is executed on a computer system.
